(19) United States
(12) Patent Application Publication
(10) Pub. No.: US 2010/0288155 A1
(43) Pub. Date: Nov. 18, 2010

(54) Track for Patient Lift Devices

(75) Inventors: Mark Chepurny, Bradford (CA); Vahideh Hashemi, Richmond Hill (CA)

Correspondence Address: THE WEBB LAW FIRM, P.C., 700 KOPPERS BUILDING, 436 SEVENTH AVENUE, PITTSBURGH, PA, 15219, US

(73) Assignee: PRISM MEDICAL LTD., Vaughan (CA)

(21) Appl. No.: 12/680,990

(22) PCT Filed: Sep. 30, 2008
(86) PCT No.: PCT/CA08/01740

§ 371 Date: Jul. 21, 2010

(30) Foreign Application Priority Data
Oct. 1, 2007 (CA) 2604860

(51) Int. Cl. B61B 3/00; B23P 15/00

(52) U.S. Cl. 104/89; 29/525.11

(57) ABSTRACT

A track section for use with a patient carrying device, the device having a carriage, and the track section being configured such that the carriage can move along the track to carry a patient, the track section comprising a connecting piece, first and second carriage-supporting pieces, and at least one fixer fixing said connector piece to said first and second carriage-supporting pieces, the track section being shaped to traverse an angle of about 90 degrees.

### FIELD OF THE INVENTION

This invention relates generally to the field of mobility devices, and more particularly, to personal lift devices of the type that may be used to raise, lower or transport horizontally a physically disabled patient for the purpose of moving the patient.

### BACKGROUND OF THE INVENTION

Personal lift or patient lift devices have been known and used in the past for the purpose of assisting with the mobility of otherwise immobilized patients. An attendant may help physically disabled patients who may be elderly, or who may have suffered a traumatic injury, stroke, or one form of illness or another, and who are unable to move about on their own.

However, often, such patients may be too heavy to lift, or the attendant may not have enough strength to help the patient move. This can be especially true for disabled patients who have reduced mobility, but otherwise normal bodily functions. Getting up, going to the bathroom, or having a bath, are examples of activities that can be very difficult for such patients.

One common type of personal lift device comprises an overhead track fixed to the ceiling. A rail carriage or trolley, having wheels, is mounted to the overhead track. A motor is operatively connected to and positioned beneath the trolley to power it, and the motor also has a lift associated with it, which lift includes a strap or chain hanging down and connecting to a harness which holds the patient. The track is typically organized to extend over the patient's bed, as well as into a bathroom area used by the patient. The patient can be raised, suspended, and moved to a desired position along the track, where the patient can be lowered into the bathtub, onto a toilet, or into bed. Typically, the movement of the trolley along the track, and the lift up and down, is controlled by an electronic controller, having buttons that are pressed by the attendant.

The track typically comprises curved sections formed to traverse about a 90 degree angle, and straight sections. Typically, curved sections of the overhead track are produced according to the following procedure. First, a section of track is produced by aluminum extrusion. Thus, the section of track produced is a single piece of aluminum, extruded so as to have the desired profile. It is common for these sections of track to be about one hundred inches in length. Then, to create a curve, the central portion of the extruded section is bent into a quarter circle. The bending is typically performed using a proprietary bending process that can create a curve of only limited sharpness without breaking or otherwise destroying the track section. The result is a section of track that comprises three subsections. At one end is a straight section approximately twenty-five inches in length. In the middle is a quarter circle having a radius of about thirty inches. At the opposite end is another straight section about twenty-five inches in length. In rooms that are too small to fit the typical curved track section (e.g. a bathroom), a turntable is used to provide a 90 degree turn.

Typically, four brackets, distributed along the curved section of track, are used to fix the track to the ceiling. The brackets are most effective in fixing the track to the ceiling when the track is straight, as the brackets contain straight fixing features that fit with corresponding fixing features on the track. Thus, the long straight end portions of the prior art curved track section are considered desirable. When the track is curved, the fixing features on the track are curved, and they don't fit as well with the fixing features on the brackets. Thus, regarding the curved portion of the track, it is considered desirable for the curve to be gradual, because the sharper the curve, the less effective the brackets will be in fixing the track section to the ceiling. Ineffective fixation can lead to the track coming away from the ceiling, creating a large risk of serious injury to the patient.

### SUMMARY OF THE INVENTION

It has generally been understood by those skilled in the art that long gradual curved track sections having long straight portions at each end were both desirable for achieving effective fixation of the track to the ceiling, and necessary because sharper curves could not be achieved by known processes. However, surprisingly and unexpectedly, the inventors have found that sharper curves can be constructed, and that such curves can be effectively fixed to the ceiling.

Therefore, what is desired in one aspect of the invention is a curved track section that is shorter than existing curved track sections, and that can fit into smaller spaces. Such shorter sections would reduce or eliminate the need for expensive turntables and the like to deal with small spaces, and would increase the flexibility of the curved section to allow it to be employed more productively. In addition, a shorter curve would require fewer fixing brackets, making it cheaper and easier to use.

In another aspect of the invention, what is desired is a curved track section that can be effectively fixed to the ceiling without long straight portions, and without necessarily having a gradual curve.

Thus, in one aspect of the invention, there is provided a track section for use with a patient carrying device, the device having a carriage and the track section being configured such that the carriage can move along the track section to carry a patient, the track section being shaped to traverse an angle of about 90 degrees, the section having a first end and a second end, the shortest distance between the first end and the second end being less than sixty inches, preferably less than 45 inches, more preferably less than 30 inches, and still more preferably less than 15 inches.

In another aspect of the invention, there is provided a track section for use with a patient carrying device, the device having a carriage, and the track section being configured such that the carriage can move along the track to carry a patient, the track section comprising a connecting piece, first and second carriage-supporting pieces, and at least one fixing element fixing said connector piece to said first and second carriage-supporting pieces, the track section being shaped to traverse an angle of about 90 degrees.

In another aspect of the invention, there is provided a method of manufacturing a track section for use with a patient carrying device, wherein the device has a carriage and the track section is configured such that the carriage can move along the track section to carry a patient, and wherein the track section is shaped traverse an angle of about 90 degrees, the method comprising the steps of:
(a) cutting a connecting piece from a sheet of metal, the connecting piece being curved so as to traverse an angle of about 90 degrees;
(b) fixing said connecting piece to said first and second carriage-supporting pieces to form said track section.

### BRIEF DESCRIPTION OF THE DRAWINGS

The invention will now be illustrated by way of example only, in the attached drawings, which show the preferred embodiment of the invention, and in which:

FIG. 1 is an exploded perspective view of the track section of the present invention;

FIG. 1A is a top view of the track section of the present invention;

FIG. 2 is an perspective view of the track section of the present invention;

FIG. 3 is a perspective view of the track section of the present invention, with fixing brackets, and connected to adjacent track sections;

FIG. 4 is a plan view of the connecting piece;

FIG. 4A is an edge view of the connecting piece;

FIG. 5 is a plan view of a carriage-supporting piece;

FIG. 5A is a cross-sectional view of a carriage-supporting piece;

FIG. 6 is a plan view of a carriage-supporting piece;

FIG. 6A is a cross-sectional view of a carriage-supporting piece;

FIG. 7 is a perspective view of a fixing element;

FIG. 8 is an end view of the track section and carriage; and

FIG. 9 is an elevation view of the track section and carriage.

### DETAILED DESCRIPTION OF THE PREFERRED EMBODIMENTS

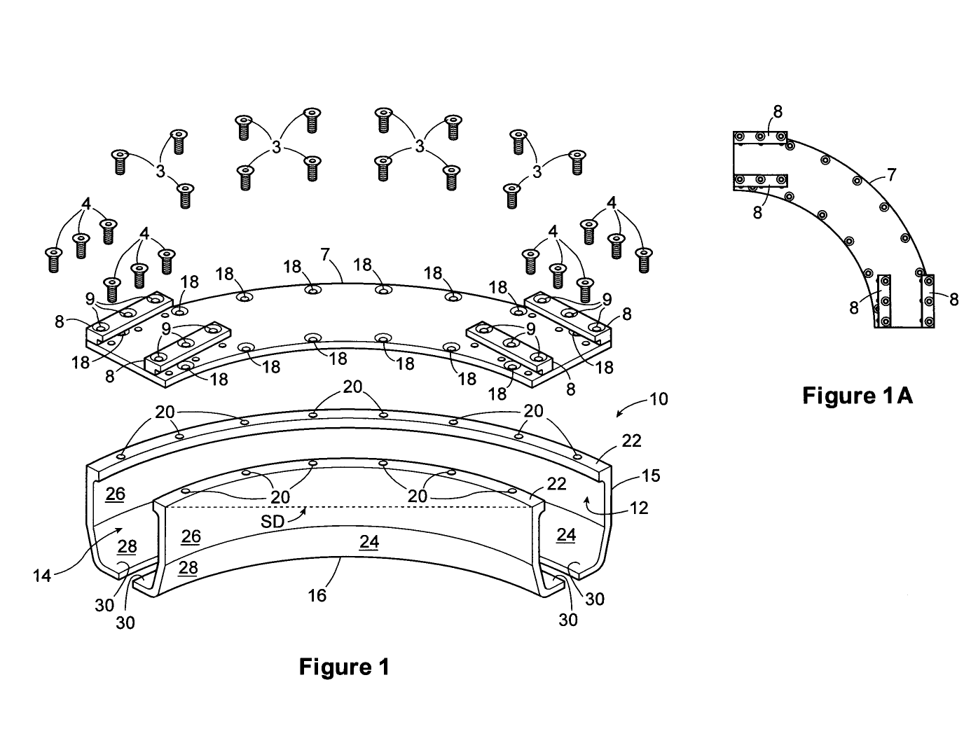

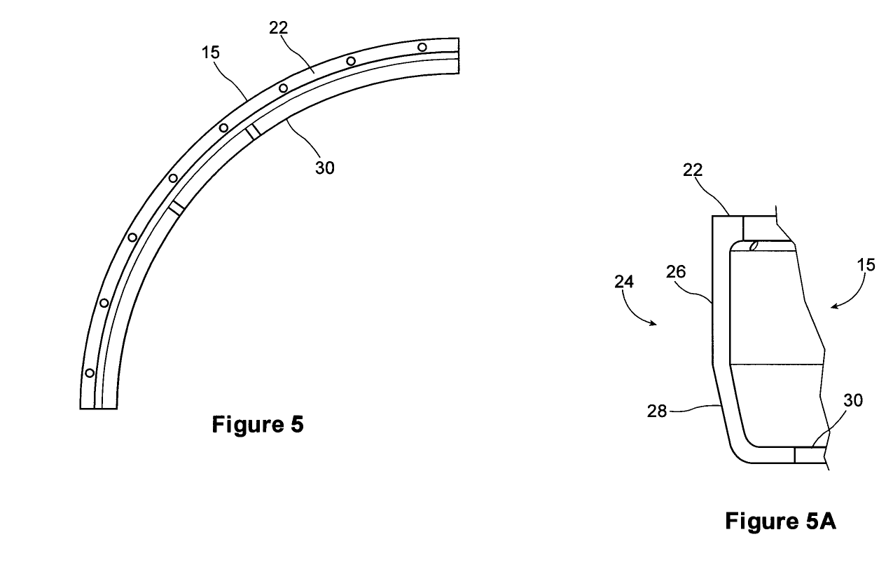

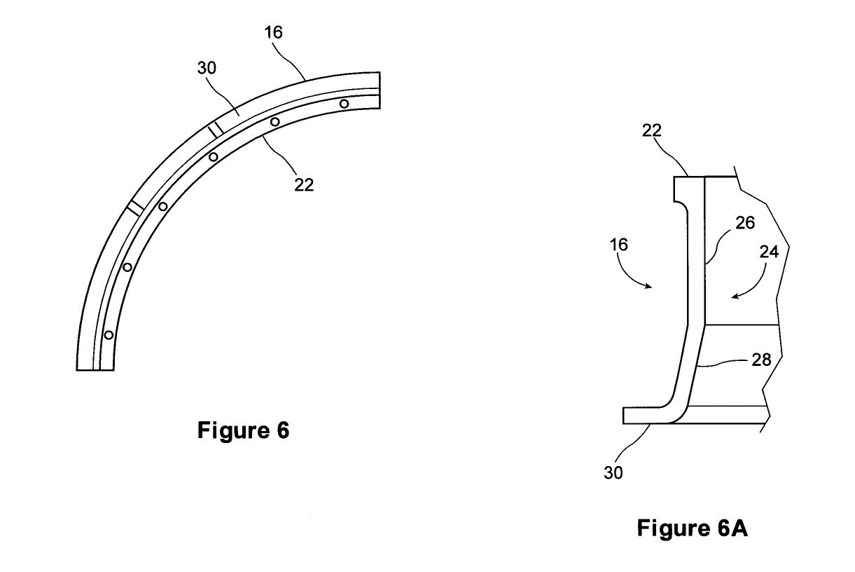

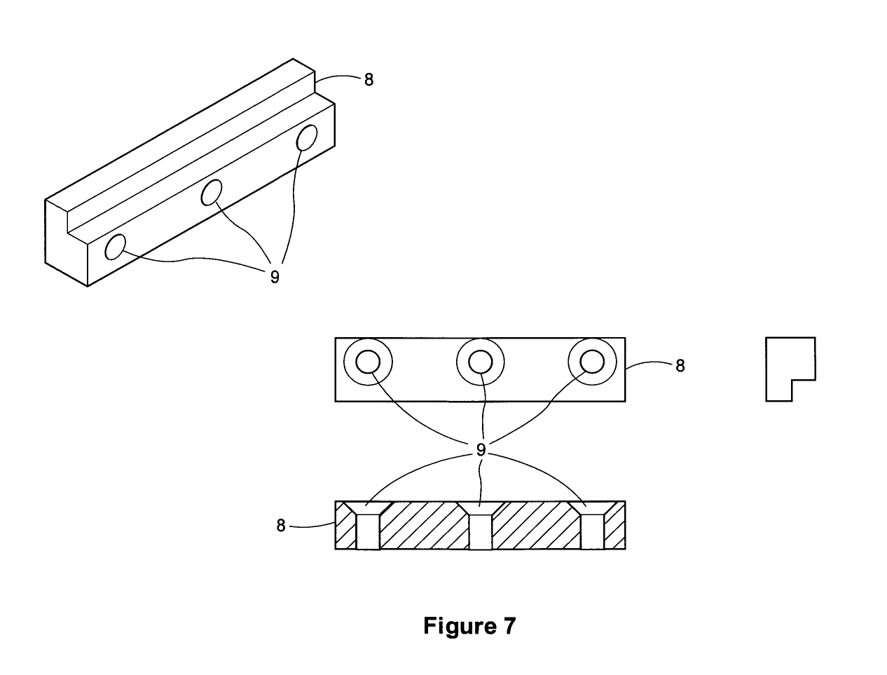

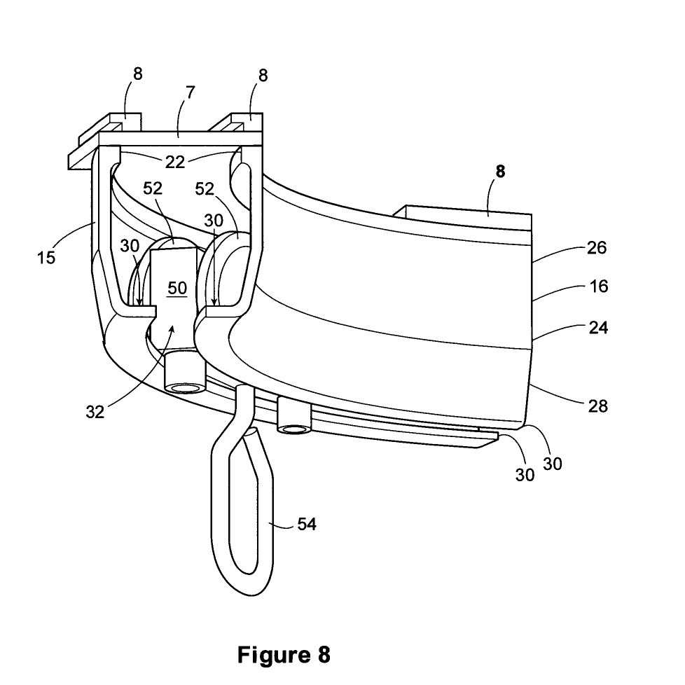

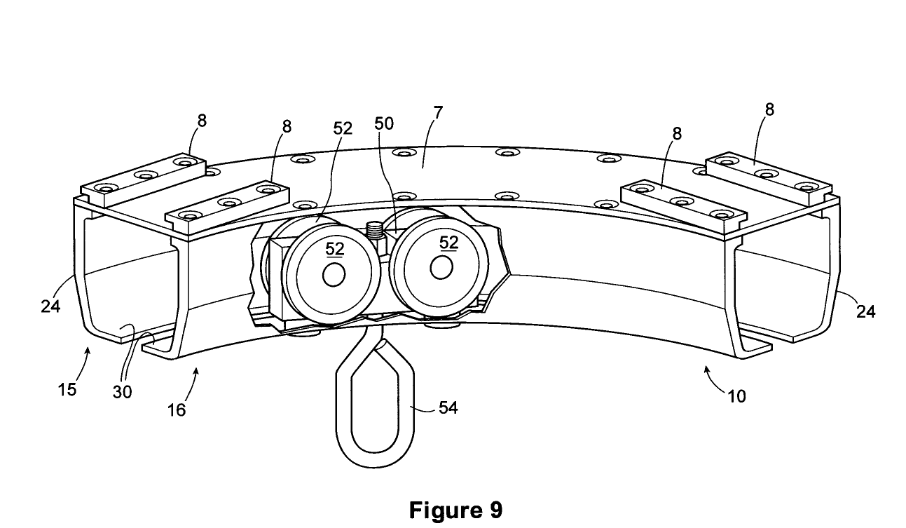

Referring now to FIGS. 1-9, an exploded view of preferred track section 10 is shown. The preferred track section comprises a connecting piece 7 and two carriage-supporting pieces 15 and 16. The track section is preferably a curved track section that traverses an angle of about 90 degrees. Thus, the direction D1 in which a carriage 50 (see FIGS. 8-9) is travelling when it enters or leaves end 12 of section 10 is angled at about 90 degrees to the direction D2 that a carriage is travelling when it enters or leaves the other end 14 of the section 10. In this specification, a track section comprises a length of track that can be connected to or disconnect from adjacent lengths of track.

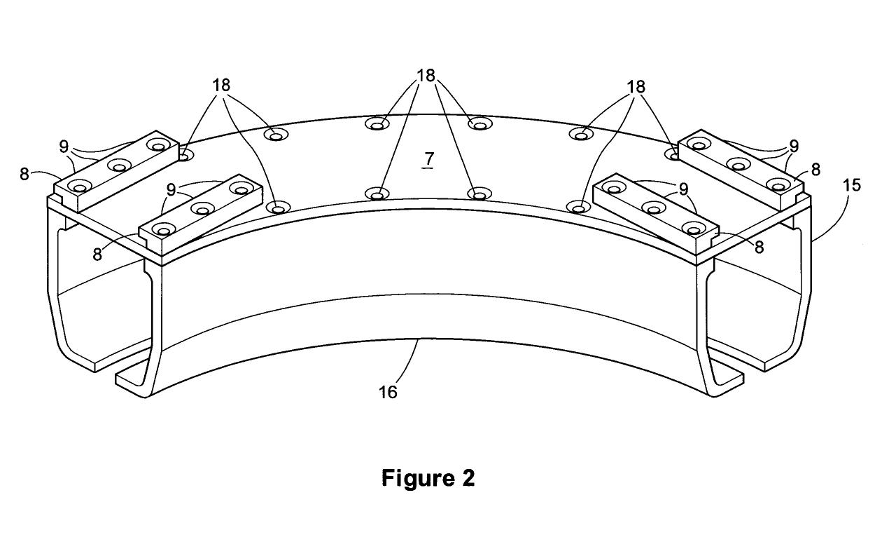

FIG. 2 shows the section 10 in assembled form. Connecting piece 7 is fixed to carriage-supporting pieces 15 and 16 by at least one fixer, preferably comprising screws 3 that are screwed through connecting piece screw holes 18 and carriage supporting pieces screw holes 20 (see FIG. 1). Holes 18 and 20 are preferably positioned to line up with each other when the connecting piece and carriage supporting pieces are in position to be fixed to one another.

It will be appreciated that the invention comprehends other types of fixers, apart from the preferred screws described above. Welding may be used, as may glue, or any other fixer adequate for fixing pieces together.

Preferably, the connecting piece 7 carries the carriage supporting pieces 15 and 16, and is configured to provide rigidity to the track section. Thus, most preferably, the connecting piece 7 is composed completely or mostly of steel. By contrast, the invention comprehends the carriage supporting pieces 15 and 16 being composed completely or mostly of aluminum, or another light metal. Even pieces 15 and 16 being composed of plastic is comprehended by the invention, as long as the plastic is sufficiently strong to support the carriage.

In the art, straight sections of track are typically made from extruded aluminum. Aluminum is preferred to heavier metals, because it is strong, yet light. Thus, it provides adequate support for the carriage; it can also be effectively and safely fixed to the ceiling, and its relatively low mass density reduces the risk that the track will come away from the ceiling.

As explained above, in the prior art, the typical prior art curved track section comprises an extruded aluminum track section that is bent by a proprietary bending process. The sharpness of the bend that can be produced by the bending process is limited. The result is a long gradual curve.

In accordance with the present invention, the end-to-end distance of the section 10 is shorter than such prior art curved sections. This is preferably, though not necessarily, achieved by using a different process for manufacturing the section 10.

Specifically, in the preferred embodiment, connector piece 7 is formed from sheet steel. The piece 7 is cut out of the sheet metal, most preferably by laser cutting, though other cutting methods are comprehended. It will be appreciated that using this preferred method to form the connecting piece 7 involves no practical limits on the sharpness of the curve of the piece 7.

Rather, the piece 7 can be cut into almost any desired shape. The reason is that no bending process with limits on bending is used. Rather, since the piece 7 is being cut out of a sheet, any desired shape can be cut.

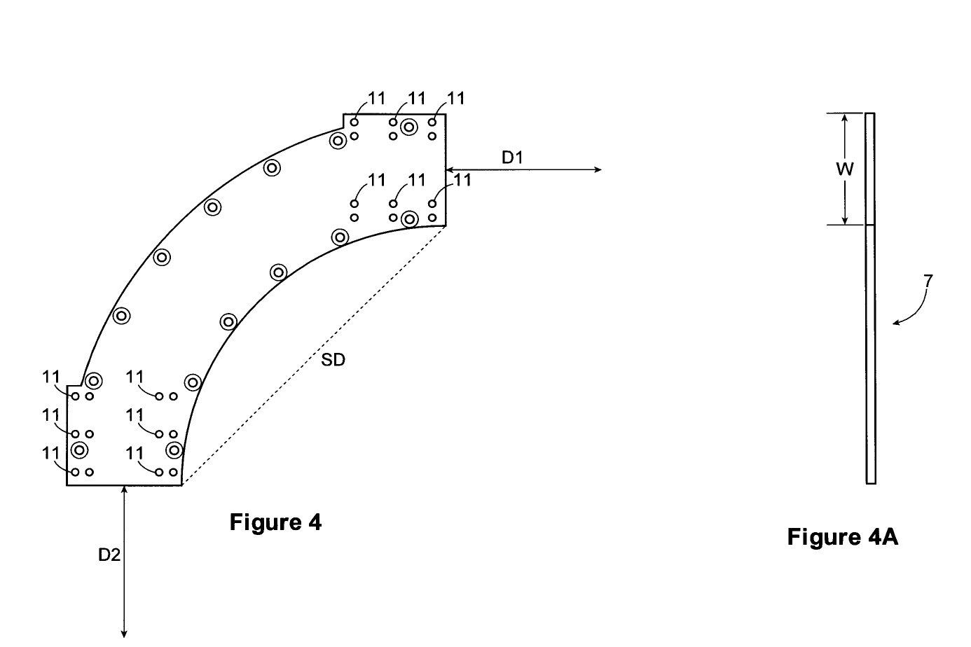

In the preferred embodiment, the piece 7 comprises about a quarter circle. As shown in FIGS. 4 and 4A, the preferred piece 7 has an inner radius of 5.359 inches, and an outer radius of 7.641 inches, for a width W of 2.282 inches. The shortest end-to-end distance of the piece 7 (shown at line SD in FIGS. 1 and 4), and thus, the shortest end-to-end distance of the section 10, is 7.579 inches. The shortest end-to-end distance of section 10 is the shortest distance between any point of end 12 of section 10 and any point of end 14 of section 10. Meanwhile, the actual length of preferred piece 7 along the inner radius is 8.418 inches, and along the outer radius, 11.905 inches.

As shown in FIG. 4A, the preferred thickness of piece 7 is 0.188 inches. It has been found that, when the piece 7 is composed of steel, this thickness is sufficient to carry the pieces 15 and 16, and to provide sufficient integrity and rigidity to the section 10, while minimizing the bulk and weight associated with the piece 7.

It will be appreciated that other forms, compositions, sizes and shapes for the piece 7 are comprehended by the invention. What is important is that the piece 7 comprise a curved section that, when fixed to the carriage-supporting pieces 15 and 16, forms a curved section 10 that traverses an angle of approximately 90 degrees.

Preferably, the pieces 15 and 16 are manufactured according to the following method. First, aluminum slabs or bars (preferably about one inch thick and three inches wide) are bent into approximately a quarter circle. Then, the bent slabs are milled to give them the profile shown in FIGS. 1, 2, 5A and 6A. The pieces 15 and 16, after profiling, include a fixing section 22 (including screw holes 20) at which pieces 15 and 16 are fixed to piece 7. Extending from fixing section 22 is side cover section 24, which preferably functions to cover the carriage path and separate it from the outside. Most preferably, section 24 includes a generally vertical, upper side cover section 26, and lower side cover section 28. Section 28 is preferably angled relative to section 26, toward the inside of section 10 under the piece.

Extending from section 28 is carriage-supporting section 30, section 30 preferably being generally horizontal. The carriage supporting section 30 forms part of the surface on which the carriage 50 is carried, and along which the carriage travels. The carriage-supporting sections 30 of pieces 15 and 16 preferably together provide the surface along which the carriage 50 travels. The carriage preferably moves using two pairs of wheels 52, with one wheel from each pair being positioned on each of the sections 30. Between the sections 30 is a carriage travel space 32, through which the carriage travels. It will be appreciated that the carriage includes a chain, strap, or other connecting element 54 that connects the carriage to a motor and/or a harness for carrying the patient. The travel space 32 provides a space through which the connecting element can move unimpeded as the carriage moves. The space 32 is sized to line up with corresponding spaces on sections of the track adjacent to section 10.

Preferably, the pieces 15 and 16 are composed of aluminum. Aluminum is advantageous because, it is, on the one hand, a relatively light substance, with the advantage that fewer or lighter fixing elements are required to fix aluminum track to the ceiling than with heavier substances. On the other hand, aluminum is still reasonably strong, and is better able to support the carriage without failing.

The section 24 is preferably configured into section 26 and angled section 28 in order to increase the carriage support strength of the section 24. Specifically, the inward angling of section 28 provides another source of support for the carriage besides the section 30 itself. The result is an additional safety factor that reduces the risk of failure of the section 10 to support the carriage. It will further be appreciated that the overall profile of section 10 will preferably match that of adjacent track sections, so that these adjacent sections will preferably have the same angling at their sides for additional support of the carriage.

As explained above, prior art curved track sections are typically made by extruding a long section of aluminum track. Generally, the extruded section of track is a one-piece section having a generally horizontal top section, two generally vertical sides, and two generally horizontal carriage-supporting portions with a space between them. The section, thus extruded, is bent using a proprietary bending process that is able to produce a bend of limited sharpness.

By contrast, pieces 15 and 16 of the present invention are made by first bending an aluminum bar or slab that is about 8-12 inches long (depending on which of piece 15 or piece 16 is being made) into a shape of approximately a quarter circle. The bent slab is then profiled to give it the profile of piece 15 or 16. It will be appreciated that the bending of an unprofiled aluminum bar does not have the same limits, in terms of the sharpness of the curve, that bending an already extruded and profiled section of track has. Thus, using the method of manufacture described herein, an adequately strong and safe curved section 10 of track can be made. Most preferably, the shortest end-to-end distance of the section 10 is about 7.5 inches. However, other sizes, appropriate to different circumstances, can be made. Sections 10 having shortest end-to-end distances of less than 15 inches, less than 30 inches, less than 45 inches and less that 60 inches are also possible. All of these embodiments provide substantially tighter curves than the prior art. The result is that curved section 10 can be used in smaller rooms in a more flexible manner, and also likely require fewer fixing brackets to fix them to the ceiling. In addition, expensive equipment, such as a turntable is less likely to be needed.

To complete the construction of section 10, piece 7 is fixed to pieces 15 and 16 to form section 10, preferably by means of screws 3 be screwed into holes 18 and 20 of piece 7 and pieces 15 and 16 respectively.

Attached to section 10 are fixing elements 8, configured to be fixed to piece 7 by screws 4, as shown in FIG. 1. To do so, screws 4 are screwed through holes 9 in elements 8 into holes 11 in piece 7. As can be seen in FIG. 1, the fixing elements 8 are preferably L-shaped in cross-section. Thus, each fixing element extends upward out of piece 7 once fixed thereto, and then switches direction 90 degrees and extends parallel to, but spaced from, the piece 7. Alternate holes 13 are preferably provided in piece 7 to permit the orientation of pieces 8 to be reversed if desired. This may be required when two sections 10 are used in sequence to create a S-curve.

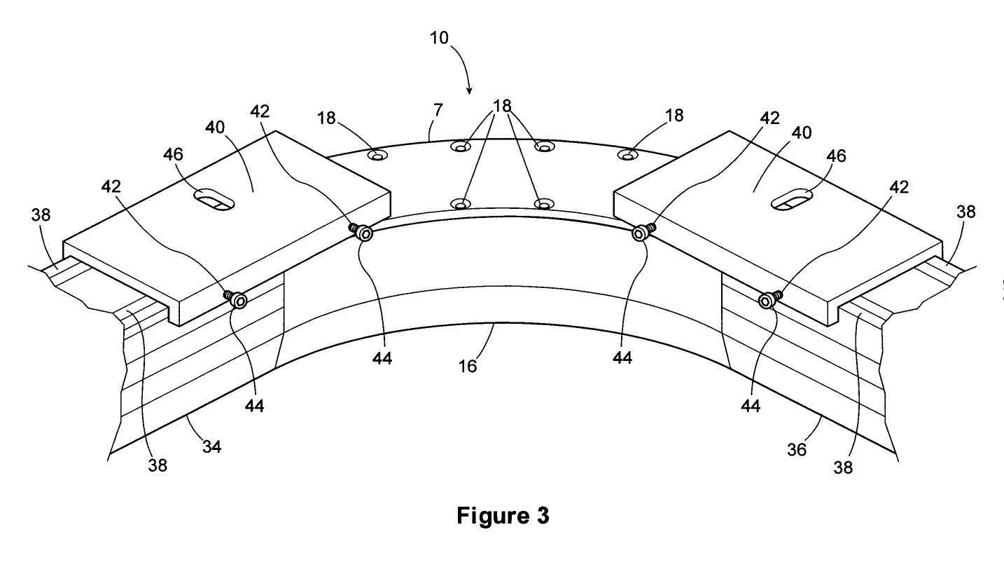

Generally, adjacent straight track sections, such as sections 34 and 36 shown in FIG. 3, are straight extruded aluminum track sections. They are extruded with L-shaped fixing features 38 extending along the length of sections 34 and 36.

Preferably, fixing elements 8 are straight—and thus do not follow the curve of piece 7 or section 10. The reasons for this preferred configuration are twofold. First, the fixing elements 8 are generally attached to the ceiling by brackets 40 that are configured to attach most effectively to straight fixing elements. One of the problems with prior art curves is that they L-shaped fixing features on their tops are curved. This is the case because when straight extruded sections are bent, the fixing features are also bent. When prior art curved sections are fixed to the ceiling, brackets configured to grip straight fixing features are used on the curved ones, and the grip is weaker. In the present invention, because the section 10 is made from a plurality of pieces, the fixing elements 8 are attached after being made separately and can be made straight, resulting in a more effective grip by brackets configured to grip straight fixing features.

Second, the elements 8 are preferably configured to line up with features 38 on adjacent sections 34, 26, so as to create one long fixing feature. The brackets 40 are preferably positioned so as to simultaneously grip both elements 8 and features 38. Thus, the sections 34 and 10 are both fixed to the ceiling by one bracket positioned at the junction of the two sections. The same is true for sections 36 and 10. The brackets thus serve a dual purpose. Not only do they fix the track to the ceiling, join curved section 10 to adjacent sections 34 and 36.

Brackets 40 are preferably configured so as to have attachment features that mate with the L-shape of elements 8. The brackets 40 are configured so that when screws 44 are screwed into holes 42 in brackets 40, and tightened, the attachment features are held in mated position with the L-shape of elements 8. The attachment features are positioned beneath the horizontal portion of the L-shape, and are held in place by the screws 44. Hardware (not shown) extends from apertures 46 in brackets 40 to fix the brackets 40 to the ceiling. The section 10 is thus fixed (via elements 8, brackets 40 and hardware), to the ceiling.

While the foregoing embodiments of the present invention have been set forth in considerable detail, it will be apparent to those skilled in the art that various modifications can be made to the invention without departing from the scope of the attached claims. Some of these variations are discussed above and others will be apparent to those skilled in the art. The section 10, which preferably comprises piece 7 fixed to pieces 15 and 16, may take a different form. Less preferably, the section 10 may comprise only two pieces rather than three. Thus, for example, there may be only one carriage-supporting piece instead of two. Alternatively, there may be two carriage supporting pieces formed so that no separate connecting piece is required. Thus, less preferably, section 10 may comprise two or more pieces. As another example, section 10, and pieces 7, 15 and 16, may traverse and angle other than 90 degrees, such as, for example, about 45 degrees or about 60 degrees.

1. A track section for use with a patient carrying device, the device having a carriage and the track section being configured such that the carriage can move along the track section to carry a patient, the track section being shaped to traverse an angle of about 90 degrees, the section having a first end and a second end, the shortest distance between the first end and the second end being less than sixty inches.

2. The track section as claimed in claim 1 wherein said shortest distance is less than forty-five inches.

3. The track section as claimed in claim 1, wherein said shortest distance is less than 30 inches.

4. The track section as claimed in claim 1, wherein said shortest distance is less than 15 inches.

5. A track section for use with a patient carrying device, the device having a carriage, and the track section being configured such that the carriage can move along the track to carry a patient, the track section comprising a connecting piece, first and second carriage-supporting pieces, and at least one fixer fixing said connector piece to said first and second carriage-supporting pieces, the track section being shaped to traverse an angle of about 90 degrees.

6. A track section as claimed in claim 5, wherein the connector piece comprises a steel piece for carrying said carriage-supporting pieces.

7. A track section as claimed in claim 5, wherein the at least one fixer comprises a plurality of screws positioned to fix the connector piece to the first and second carriage-supporting pieces.

8. A track section as claimed in claim 6, wherein the first and second carriage-supporting pieces each comprise an aluminum piece.

9. A track section as claimed in claim 5, the track section further comprising at least one fixing element, fixed to the connecting piece, for fixing the track section to a ceiling.

10. A track section as claimed in claim 9, wherein the at least one fixing element is substantially straight along its length.

11. A track section as claimed in claim 10, wherein the at least one fixing element is substantially L-shaped in cross-section.

12. A track section as claimed in claim 10, wherein the at least one fixing element comprises four fixing elements.

13. A method of manufacturing a track section for use with a patient carrying device, wherein the device has a carriage and the track section is configured such that the carriage can move along the track section to carry a patient, and wherein the track section is shaped traverse an angle of about 90 degrees, the method comprising the steps of:
(a) cutting a connecting piece from a sheet of metal, the connecting piece being curved so as to traverse an angle of about 90 degrees;
(b) fixing said connecting piece to said first and second carriage-supporting pieces to form said track section.

14. The method as claimed in claim 13, wherein said step (b) comprises fixing said connecting pieces to said first and second carriage-supporting pieces using screws.

15. The method as claimed in claim 13, wherein the method further comprises forming each carriage supporting piece according to the following steps:
bending an aluminum slab such that it is curved so as to traverse an angle of about 90 degrees; and
profiling said slab so as to form the carriage supporting piece.

16. The method as claimed in claim 15, wherein the profiling step comprises milling the slab to produce the profile of the carriage-supporting piece.

17. The method as claimed in claim 13, wherein the cutting step comprises laser cutting.

18. The method as claimed in claim 13, the method further comprising the step of making screw holes in said connecting piece to permit screws to be used to fix the connecting piece to the carriage-supporting pieces.

19. The method as claimed in claim 17, the method further comprising making screw holes in the carriage-supporting pieces to permit screws to be used to fix the connecting piece to the carriage-supporting pieces.
